(19) United States
(12) Patent Application Publication
(10) Pub. No.: US 2024/0413453 A1
(43) Pub. Date: Dec. 12, 2024

(54) WATERTIGHT BATTERY LOWER CASE AND MANUFACTURING METHOD THEREOF

(71) Applicant: HYUNDAI MOBIS CO., LTD., Seoul (KR)

(72) Inventor: Ho Jin PARK, Yongin-si (KR)

(73) Assignee: HYUNDAI MOBIS CO., LTD., Seoul (KR)

(21) Appl. No.: 18/588,367

(22) Filed: Feb. 27, 2024

(30) Foreign Application Priority Data
Jun. 12, 2023 (KR) 10-2023-0074703

(51) Int. Cl. H01M 50/24; H01M 50/231

(52) U.S. Cl. CPC H01M 50/24; H01M 50/231

(57) ABSTRACT

A watertight battery lower case with higher productivity due to a shorter adhesive curing time and a lower welding defect rate by selectively applying a structural adhesive to some joint layers of the watertight battery case and welding the other joint layers to each other, and a manufacturing method thereof.

### CROSS-REFERENCE TO RELATED APPLICATIONS

This application claims priority under 35 U.S.C. § 119 to Korean Patent Application No. 10-2023-0074703, filed on Jun. 12, 2023, in the Korean Intellectual Property Office, the disclosure of which is incorporated herein by reference in its entirety.

### TECHNICAL FIELD

The following disclosure relates to a watertight battery case.

### BACKGROUND

A conventional watertight battery pack may watertight a battery by attaching a bracket and a reinforcing material for stronger rigidity of a battery case respectively to the inside and outside of the case. Here, it is most important that the bracket and the reinforcing material are attached to the same point. Therefore, the bracket and the reinforcing material may be triple welded all together while having the battery case interposed therebetween.

However, if a micropore occurs in a triple welded area, the battery case may fail to meet an IPX7 standard (i.e., no moisture inflow when submerged at 1 m for 30 minutes) for a watertight battery, and the case may be defective. Due to a feature of a welding process, based on a pressure condition, a welding current condition, or a welding speed condition, the longer the joining depth, the higher the occurrence possibilities of the micropore or a pore. In addition, in a case of spot welding, it may be difficult to achieve uniform quality welding based on the wear of a welding tip or a welding environment. In addition, it is virtually impossible to inspect later whether the pore occurs at the triple welded area in a current high-voltage battery steel case.

Accordingly, a plan to exclude the spot welding and use a structural adhesive has also been proposed.

### SUMMARY

An embodiment of the present disclosure is directed to providing a watertight battery lower case with higher productivity due to a shorter adhesive curing time and a lower welding defect rate by selectively applying a structural adhesive to some joint layers of the watertight battery case and welding the other joint layers to each other, and a manufacturing method thereof.

In one general aspect, a watertight battery lower case may include: a main case part applied to a lower part of a battery module to protect the battery module, and having a flat shape; an internal bracket part disposed between one surface of the main case part and the battery module to support their joining; a sub-assembly part having one surface in contact with and stacked on another surface of the main case part; and a fixing part joining and fixing the main case part, the internal bracket part, and the sub-assembly part to one another, wherein the fixing part simultaneously includes a welded joint joined by welding and an adhesive joint joined by an adhesive, and the main case part, the internal bracket part, and the sub-assembly part are joined to one another by sharing a certain joint region together.

The main case part and the internal bracket part each include welding holes at corresponding positions, the welded joint is formed by simultaneously passing through the main case part and the internal bracket part via the welding holes, the adhesive joint is formed by adhesively joining to the main case part and the sub-assembly part by coating the adhesive therebetween, and the sub-assembly part has an adhesive storage part engraved therein and accommodating the adhesive inside.

The adhesive storage part may include a first adhesive storage groove which is a step recessed to a certain depth in a predetermined adhesive storage region including a region overlapping a position of the welding hole.

The adhesive storage part may include a second adhesive storage groove having recesses that are formed in a regular interval in a predetermined adhesive storage region including a region overlapping a position of the welding hole.

When a formation direction of the welding hole and contact surfaces of the main case part and the internal bracket part are neither perpendicular nor parallel to each other and have a predetermined incline therebetween, the adhesive storage part may include a third adhesive storage groove etched stepwise in a predetermined adhesive storage region including a region overlapping a position of the welding hole.

When the density of the welded joint is less than a predetermined reference value, the adhesive joint may be coated by the adhesive with a greater amount than a maximum amount of the adhesive accommodated in the adhesive storage part including a region overlapping a position of the welding hole.

The main case part and the internal bracket part may each include welding holes at corresponding positions, and the welded joint may be welded by simultaneously passing through the main case part, the internal bracket part, and the sub-assembly part via the welding holes.

For the adhesive joint, the adhesive may be coated between the internal bracket part and the battery module or coated on the other surface of the sub-assembly part.

The sub-assembly part may further include a coating part including a coating material on an outer surface of the sub-assembly part.

In another general aspect, a manufacturing method of a watertight battery lower case in which an internal bracket part is disposed on one surface of a main case part, and a sub-assembly part is disposed on another surface of the main case part, may include: a step (a) of welding the main case part and the internal bracket part to each other; a step (b) of joining the main case part and the sub-assembly part to each other; and a step (c) of pressing the main case part, the internal bracket part, and the sub-assembly part together, wherein the main case part, the internal bracket part, and the sub-assembly part are joined to one another by sharing a certain joint region together.

The step (b) includes forming an adhesive joint by coating an adhesive between the main case part and the sub-assembly part.

The step (b) may include a step (b1) of inspecting the density of a welded joint between the main case part and the internal bracket part, and the step (b) may further include a step (b2) of coating the adhesive with a greater amount than a maximum amount of the adhesive accommodated in an adhesive storage part of the sub-assembly part when the density of the welded joint in the step (b1) is less than a predetermined reference value.

In the step (b), the sub-assembly part, the main case part, and the internal bracket part may be welded to one another by a welded joint.

The method may further include, following the step (b), a step (d) of coating an adhesive between the internal bracket part and a battery module, or coating the adhesive on an outer surface of the sub-assembly part.

The method may further include, following the step (b), a step (e) of stacking a coating part including a coating material on an outer surface of the sub-assembly part.

### BRIEF DESCRIPTION OF THE DRAWINGS

FIG. 1 is a partial cross-sectional view of a watertight battery lower case of the present disclosure.

FIG. 2 is a partial cross-sectional view of a first embodiment of the watertight battery lower case of the present disclosure.

FIG. 3 is a partial cross-sectional view of a second embodiment of the watertight battery lower case of the present disclosure.

FIG. 4 is a partial cross-sectional view of a third embodiment of the watertight battery lower case of the present disclosure.

FIG. 5 is a partial cross-sectional view of a fourth embodiment of the watertight battery lower case of the present disclosure.

FIG. 6 is a partial cross-sectional view of a fifth embodiment of the watertight battery lower case of the present disclosure.

FIG. 7 is a partial cross-sectional view of a sixth embodiment of the watertight battery lower case of the present disclosure.

FIG. 8 is a flow chart showing a manufacturing method of a watertight battery lower case of the present disclosure.

FIG. 9 is a flow chart showing a detailed step of a step of joining a main case part and a sub-assembly part to each other.

FIG. 10 is a flow chart showing a first embodiment of the manufacturing method of a watertight battery lower case of the present disclosure.

FIG. 11 is a flow chart showing a second embodiment of the manufacturing method of a watertight battery lower case of the present disclosure.

### DETAILED DESCRIPTION OF EMBODIMENTS

Hereinafter, the spirit of the present disclosure is described in more detail with reference to the accompanying drawings. Prior to the description, terms and words used in the specification and claims are not to be construed as general or dictionary meanings, and are to be construed as meanings and concepts meeting the spirit of the present disclosure based on a principle in which the inventors may appropriately define the concepts of the terms in order to describe their inventions in the best mode.

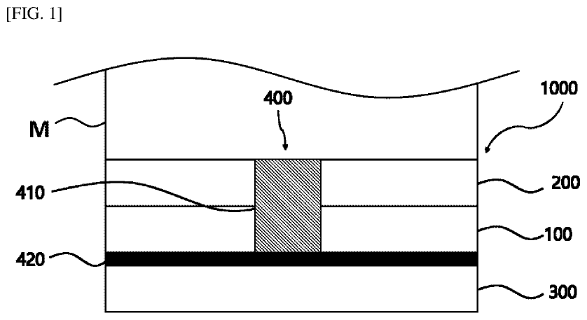

Hereinafter, a basic configuration of a watertight battery lower case 1000 of the present disclosure is described with reference to FIG. 1.

As shown in FIG. 1, the watertight battery lower case 1000 of the present disclosure may include a main case part 100. The main case part 100 may be applied to a lower part of a battery module M to protect the battery module M, and have a flat shape. In addition, the watertight battery lower case 1000 of the present disclosure may include an internal bracket part 200 disposed between one surface of the main case part 100 and the battery module M to support their joining. In addition, the watertight battery lower case 1000 of the present disclosure may include a sub-assembly part 300 having one surface in contact with and stacked on the other surface of the main case part 100.

The watertight battery lower case 1000 of the present disclosure may include a fixing part 400 joining and fixing the main case part 100, the internal bracket part 200, and the sub-assembly part 300 described above to one another. The fixing part 400 may simultaneously include a welded joint 410 joined by welding and an adhesive joint 420 joined by an adhesive. Here, the adhesive for the adhesive joint 420 may be a structural adhesive such as epoxy. That is, the watertight battery lower case 1000 of the present disclosure may use both of welding and adhesive methods, thereby improving watertight performance and significantly lowering a defect rate by offsetting the pros and cons of each of the welding and adhesive methods. Here, the main case part 100, the internal bracket part 200, and the sub-assembly part 300 may be required to be joined to one another by sharing a certain joint region together due to other functional problems of a battery, and the fixing part 400 may include the welded joint 410 and the adhesive joint 420, thus maintaining watertightness of a triple joint area.

To describe the fixing part 400 in more detail, the main case part 100 and the internal bracket part 200 may each include welding holes at corresponding positions. The welded joint 410 may be welded by simultaneously passing through the main case part 100 and the internal bracket part 200 via the welding holes. The adhesive joint 420 may be adhesively joined to the main case part 100 and the sub-assembly part 300 by coating the adhesive therebetween.

Here, in order to further increase an adhesive strength, the sub-assembly part 300 may have an adhesive storage part engraved in one surface thereof and accommodating the adhesive inside. It is thus possible to increase a coating amount of the adhesive, and increase the adhesive strength by increasing an adhesive depth. In addition, even when the adhesive is joined to the welded joint 410 (and a pore occurs), the over-coated adhesive may penetrate into the pore of the welded joint 410 to support the welded joint 410. Its detail is described below.

The main case part 100, the internal bracket part 200, and the sub-assembly part 300, which are joined to one another through the welded joint 410 and the adhesive joint 420 in this way, may be simultaneously pressed to increase the joining strength and watertightness of the case 1000. Here, the over-coated adhesive may compensate for a defect of the welded joint 410. Here, a pressing force may be provided in such a way that a pressure is applied by performing additional welding in a non-watertight region.

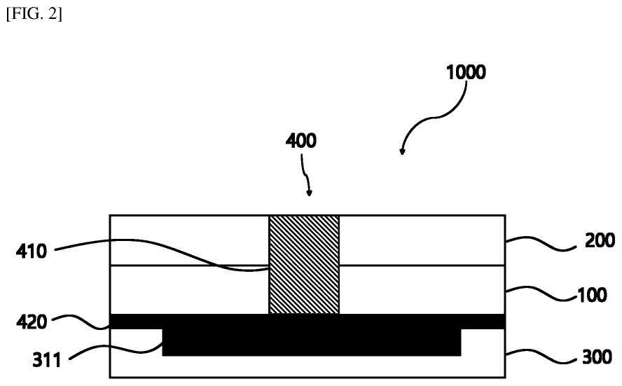

Hereinafter, a first embodiment of the watertight battery lower case 1000 of the present disclosure is described with reference to FIG. 2.

In the first embodiment of the watertight battery lower case 1000 of the present disclosure shown in FIG. 2, the adhesive storage part may include a first adhesive storage groove 311 which is a step recessed to a certain depth in a predetermined adhesive storage region including a region corresponding to the position of the welding hole. Here, the first adhesive storage groove 311 may be formed in the center of the sub-assembly part 300. The present disclosure may include the first adhesive storage groove 311, thus increasing the coating amount of the adhesive, and increasing the adhesive depth to thus increase the adhesive strength.

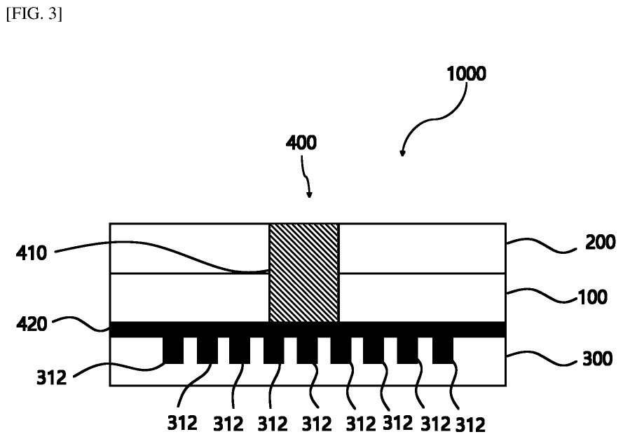

Hereinafter, a second embodiment of the watertight battery lower case 1000 of the present disclosure is described with reference to FIG. 3.

In the second embodiment of the watertight battery lower case 1000 of the present disclosure shown in FIG. 3, the adhesive storage part may include a second adhesive storage groove 312 having recesses that are formed in a regular interval in the predetermined adhesive storage region including the region corresponding to the position of the welding hole. Here, the second adhesive storage groove 312 may be formed in a straight line in an extension direction of the sub-assembly part 300, or may be formed in a checkerboard shape. As the second embodiment of the watertight battery lower case 1000 of the present disclosure is applied, the regions where the adhesive is stored may be separated from each other. Therefore, even if a crack or the defect occurs in any direction, the adhesive may be easily moved during the pressing to compensate for the defect.

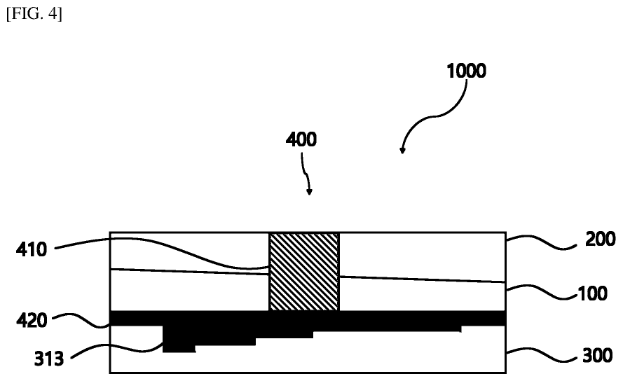

Hereinafter, a third embodiment of the watertight battery lower case 1000 of the present disclosure is described with reference to FIG. 4.

In the third embodiment of the watertight battery lower case 1000 of the present disclosure shown in FIG. 4, when a formation direction of the welding hole and contact surfaces of the main case part 100 and the internal bracket part 200 are neither perpendicular nor parallel to each other and have a predetermined incline therebetween, the adhesive storage part may include a third adhesive storage groove 313 etched stepwise in the predetermined adhesive storage region including the region corresponding to the position of the welding hole.

When the formation direction of the welding hole and the contact surfaces of the main case part 100 and the internal bracket part 200 are neither perpendicular nor parallel to each other and have the predetermined incline therebetween, there is a high possibility in which the defect occurs and a joining surface itself is inclined in a severe case. Here, as the third embodiment of the watertight battery lower case 1000 of the present disclosure is applied, the inclined joining surface may be supported by the adhesive, thus securing increased joining stability.

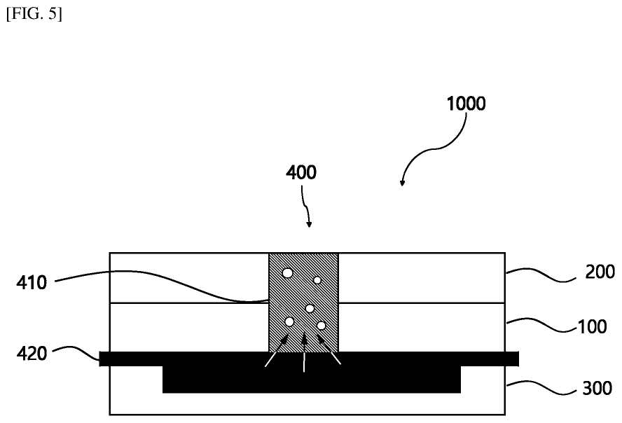

Hereinafter, a fourth embodiment of the watertight battery lower case 1000 of the present disclosure is described with reference to FIG. 5.

In the fourth embodiment of the watertight battery lower case 1000 of the present disclosure shown in FIG. 5, it is preferable for the adhesive joint 420 to be coated by the adhesive with a greater amount than the maximum amount of the adhesive accommodated in the adhesive storage part including the region corresponding to the position of the welding hole.

In more detail, during a process of the welded joint 410 in a battery pack production line, a welding pressure, a welding current, a welding speed, or the like may be monitored and compared with a predetermined reference value, thereby predicting in advance whether the welded joint 410 has lower density to cause the pore. When a prediction result indicates that the pore is highly likely to occur, the adhesive may be coated with the greater amount than the maximum amount of the adhesive accommodated in the adhesive storage part. Accordingly, the adhesive may be impregnated into the pore to maintain the joining strength of the case 1000 and increase its watertightness.

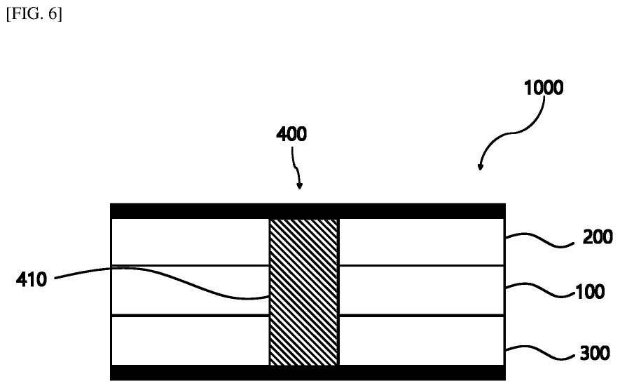

Hereinafter, a fifth embodiment of the watertight battery lower case 1000 of the present disclosure is described with reference to FIG. 6.

In the fifth embodiment of the watertight battery lower case 1000 of the present disclosure shown in FIG. 6, the main case part 100 and the internal bracket part 200 each include the welding holes at the corresponding positions, and the welded joint 410 may be welded by simultaneously passing through the main case part 100, the internal bracket part 200, and the sub-assembly part 300 via the welding holes. Here, in order to compensate for the welded joint 410, the adhesive may be coated and cured between the internal bracket part 200 and the battery module M or coated on the other surface of the sub-assembly part 300. It is thus possible to offset the defect of the welded joint 410.

Furthermore, in the case where the welded joint 410 is predicted to have the lower density, and the pore is thus highly likely to occur, it is possible to maintain the joining strength and increase the watertightness in such a way that the adhesive with the greater amount than its reference amount impregnates into the pore.

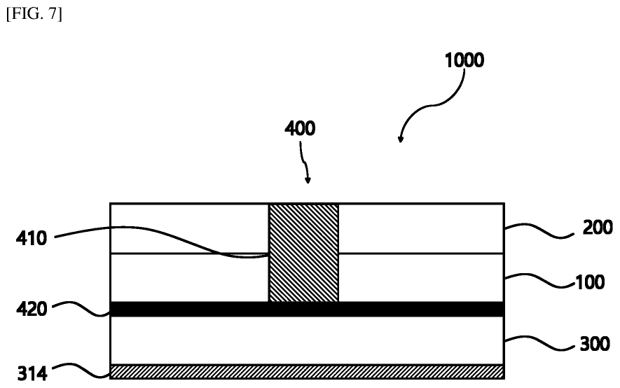

Hereinafter, a sixth embodiment of the watertight battery lower case 1000 of the present disclosure is described with reference to FIG. 7.

In the sixth embodiment of the watertight battery lower case 1000 of the present disclosure shown in FIG. 7, the sub-assembly part 300 may further include a coating part 314 including a coating material on the other surface. The coating part 314 may be a waterproof coating layer. The sub-assembly part 300 may include the coating part 314, thereby compensating for the watertightness of its surface.

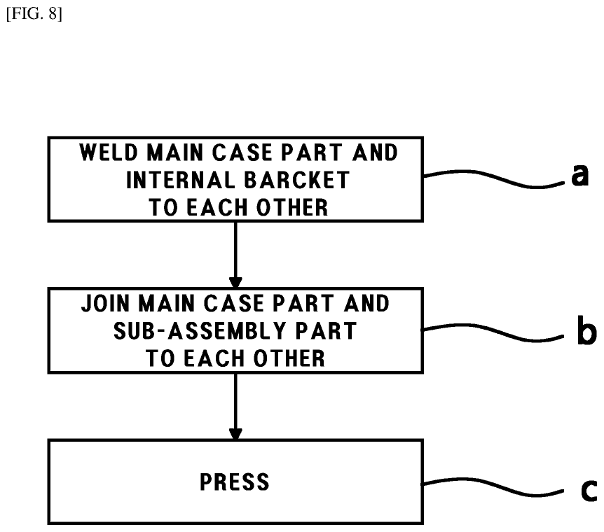

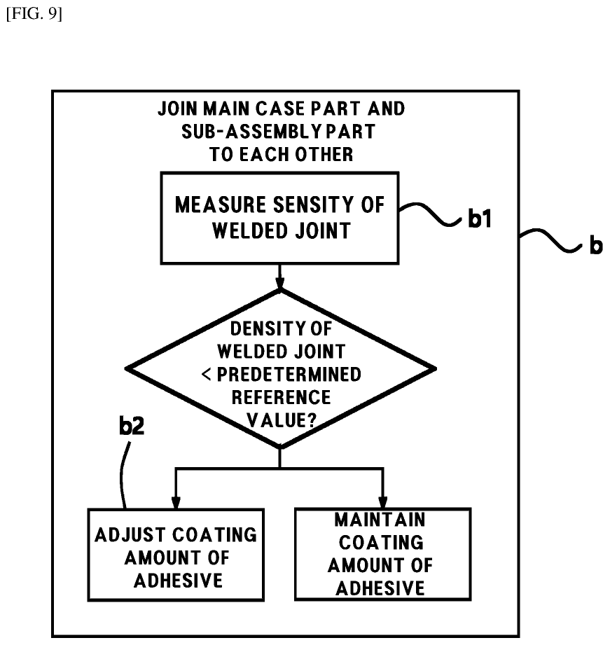

Hereinafter, a manufacturing method of a watertight battery lower case 1000 of the present disclosure is described in more detail with reference to FIGS. 8 and 9.

As shown in FIG. 8, the manufacturing method of the watertight battery lower case 1000 of the present disclosure may be a method of manufacturing the watertight battery lower case 1000 in which an internal bracket part 200 is disposed on one surface of a main case part 100, and a sub-assembly part 300 is disposed on the other surface of the main case part 100. The method may include: a step (a) of welding the main case part 100 and the internal bracket part 200 to each other; a step (b) of joining the main case part 100 and the sub-assembly part 300 to each other; and a step (c) of pressing the main case part 100, the internal bracket part 200, and the sub-assembly part 300 together. Here, in the step (c), a pressure may be applied by performing additional welding in a non-watertight region. Here, it is preferable that the main case part 100, the internal bracket part 200, and the sub-assembly part 300 are joined to one another by sharing a certain joint region together.

For example, as shown in FIG. 9, in the step (b), it is preferable that an adhesive for an adhesive joint 420 is coated between the main case part 100 and the sub-assembly part 300. In addition, the step (b) may include a step (b1) of inspecting the density of a welded joint 410, and it is preferable that the step (b) further includes a step (b2) of coating the adhesive with a greater amount than the maximum amount of the adhesive accommodated in an adhesive storage part of the sub-assembly part 300 when the density of the welded joint 410 in the step (b1) is less than a predetermined reference value.

In the step (b1), during a process of the welded joint 410 in a battery pack production line, a welding pressure, a welding current, a welding speed, or the like may be monitored and compared with the predetermined reference value, thereby predicting in advance whether the welded joint 410 has lower density to cause a pore. In the step (b1), the coating amount of the adhesive may not be adjusted when the density of the welded joint 410 meets the reference value.

Accordingly, even when the adhesive is joined to the welded joint 410 (and the pore occurs) while performing the step (c) later, the over-coated adhesive may penetrate into the pore of the welded joint 410 to support the welded joint 410. In addition, even if a defect exists in the sub-assembly part 300 or the main case part 100, the over-coated adhesive may penetrate into the corresponding area and compensate for the defect.

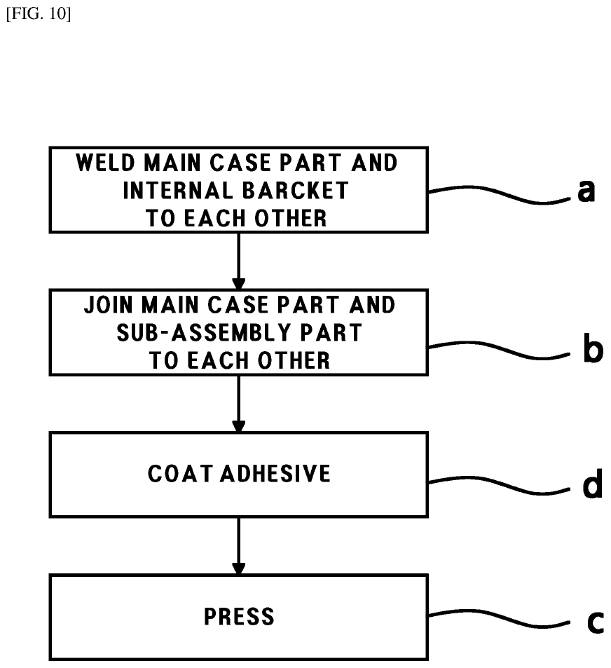

As another example, as shown in FIG. 10, in the step (b), the sub-assembly part 300 and the main case part 100 may be welded to each other by the welded joint 410. That is, the steps (a) and (b) may be performed together for the sub-assembly part 300, the main case part 100, and the internal bracket part 200 to be welded to one another by the welded joint 410. The method may then further include a step (d) following the step (b), the step (d) of coating the adhesive between the internal bracket part 200 and a battery module M, or coating the adhesive on the other surface of the sub-assembly part 300. The coated adhesive may be cured to protect the welded joint 410 even if the defect occurs in the welded joint 410.

Furthermore, in a case where the welded joint 410 is predicted to have the lower density, and the pore is thus highly likely to occur, it is possible to maintain the joining strength of the case 1000 and increase its watertightness in such a way that the adhesive with the greater amount than its reference amount impregnates into the pore.

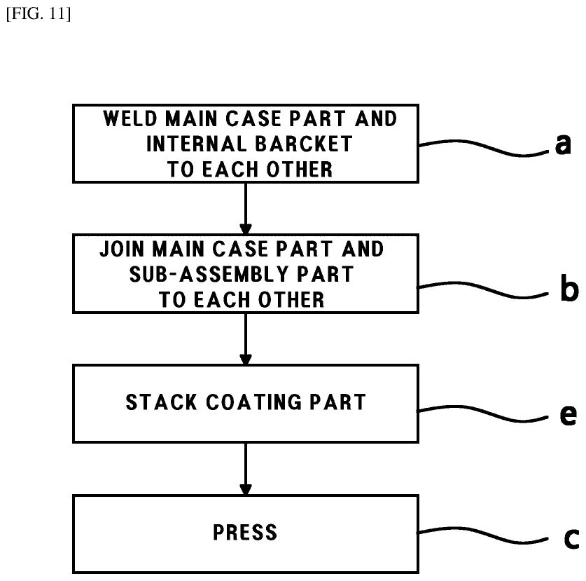

In addition, as shown in FIG. 11, the manufacturing method of the watertight battery lower case 1000 of the present disclosure may further include a step (e) of stacking a coating part 314 including a coating material on the other surface of the sub-assembly part 300. The step (e) may follow the step (b). The coating part 314 may be a waterproof coating layer. The case 1000 may include the coating part 314, thereby compensating for the watertightness of a surface of the sub-assembly part 300.

As set forth above, the present disclosure may provide the watertight battery lower case with the higher productivity due to the shorter adhesive curing time and the lower welding defect rate by selectively applying the structural adhesive to some joint layers of the watertight battery case and welding the other joint layers to each other, and the manufacturing method thereof.

The spirit of the present disclosure should not be limited to the embodiments described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A watertight battery lower case comprising:
a main case part applied to a lower part of a battery module to protect the battery module, and having a flat shape;
an internal bracket part disposed between one surface of the main case part and the battery module to support their joining;
a sub-assembly part having one surface in contact with and stacked on another surface of the main case part; and
a fixing part joining and fixing the main case part, the internal bracket part, and the sub-assembly part to one another,
wherein the fixing part simultaneously includes a welded joint joined by welding and an adhesive joint joined by an adhesive, and
the main case part, the internal bracket part, and the sub-assembly part are joined to one another by sharing a certain joint region together.

2. The case of claim 1, wherein the main case part and the internal bracket part each include welding holes at corresponding positions,
the welded joint is formed by simultaneously passing through the main case part and the internal bracket part via the welding holes,
the adhesive joint is formed by adhesively joining the main case part to the sub-assembly part by coating the adhesive therebetween, and
the sub-assembly part has an adhesive storage part engraved therein and accommodating the adhesive inside.

3. The case of claim 2, wherein the adhesive storage part includes a first adhesive storage groove which is a step recessed to a certain depth in a predetermined adhesive storage region including a region overlapping a position of the welding hole.

4. The case of claim 2, wherein the adhesive storage part includes a second adhesive storage groove having recesses that are formed in a regular interval in a predetermined adhesive storage region including a region overlapping a position of the welding hole.

5. The case of claim 2, wherein when a formation direction of the welding hole and contact surfaces of the main case part and the internal bracket part are neither perpendicular nor parallel to each other and have a predetermined incline therebetween,
the adhesive storage part includes a third adhesive storage groove etched stepwise in a predetermined adhesive storage region including a region overlapping a position of the welding hole.

6. The case of claim 2, wherein when the density of the welded joint is less than a predetermined reference value, the adhesive joint is coated by the adhesive with a greater amount than a maximum amount of the adhesive accommodated in the adhesive storage part including a region overlapping a position of the welding hole.

7. The case of claim 1, wherein the main case part and the internal bracket part each include welding holes at corresponding positions, and
the welded joint is formed by simultaneously passing through the main case part, the internal bracket part, and the sub-assembly part via the welding holes.

8. The case of claim 7, wherein for the adhesive joint, the adhesive is coated between the internal bracket part and the battery module or coated on an outer surface of the sub-assembly part.

9. The case of claim 7, wherein the sub-assembly part further includes a coating part including a coating material on an outer surface of the sub-assembly part.

10. A manufacturing method of a watertight battery lower case in which an internal bracket part is disposed on one surface of a main case part, and a sub-assembly part is disposed on another surface of the main case part, the method comprising:
a step (a) of welding the main case part and the internal bracket part to each other;
a step (b) of joining the main case part and the sub-assembly part to each other; and
a step (c) of pressing the main case part, the internal bracket part, and the sub-assembly part together,
wherein the main case part, the internal bracket part, and the sub-assembly part are joined to one another by sharing a certain joint region together.

11. The method of claim 10, wherein the step (b) includes forming an adhesive joint by coating an adhesive between the main case part and the sub-assembly part.

12. The method of claim 11, wherein the step (b) includes a step (b1) of inspecting the density of a welded joint between the main case part and the internal bracket part, and
the step (b) further includes a step (b2) of coating the adhesive with a greater amount than a maximum amount of the adhesive accommodated in an adhesive storage part of the sub-assembly part when the density of the welded joint in the step (b1) is less than a predetermined reference value.

13. The method of claim 10, wherein in the step (b), the sub-assembly part, the main case part, and the internal bracket part are welded to one another by a welded joint.

14. The method of claim 13, further comprising, following the step (b), a step (d) of coating an adhesive between the internal bracket part and a battery module, or coating the adhesive on an outer surface of the sub-assembly part.

15. The method of claim 10, further comprising, following the step (b), a step (e) of stacking a coating part including a coating material on an outer surface of the sub-assembly part.
